(19) United States
(12) Patent Application Publication
(10) Pub. No.: US 2003/0208446 A1
(43) Pub. Date: Nov. 6, 2003

(54) Method for loading money, an electronic device, and a system

(76) Inventor: Uusilehto Janne, Tampere (FI)

Correspondence Address: PERMAN & GREEN, 425 POST ROAD, FAIRFIELD, CT, 06824, US

(21) Appl. No.: 09/942,382

(22) Filed: Aug. 29, 2001

(30) Foreign Application Priority Data
Sep. 4, 2000 (FI) 20001939

(51) Int. Cl. G06F 17/60

(52) U.S. Cl. 705/41

(57) ABSTRACT

The present invention relates to a method for loading money from money loading means (15) to money depositing means (1). In the method, money is deposited in electrical form. In the method, a loading condition is determined. Further in the method, a signal transmitted by the money loading means (15) is received, and said loading condition is examined. Thus, if the loading condition is fulfilled and if the signal transmitted by the loading means (15) can be received, money is loaded automatically.

The present invention relates to a method for loading money according to the preamble of the appended claim 1. The invention also relates to an electronic device according to the preamble of the appended claim 9, as well as a system according to the preamble of the appended claim 14.

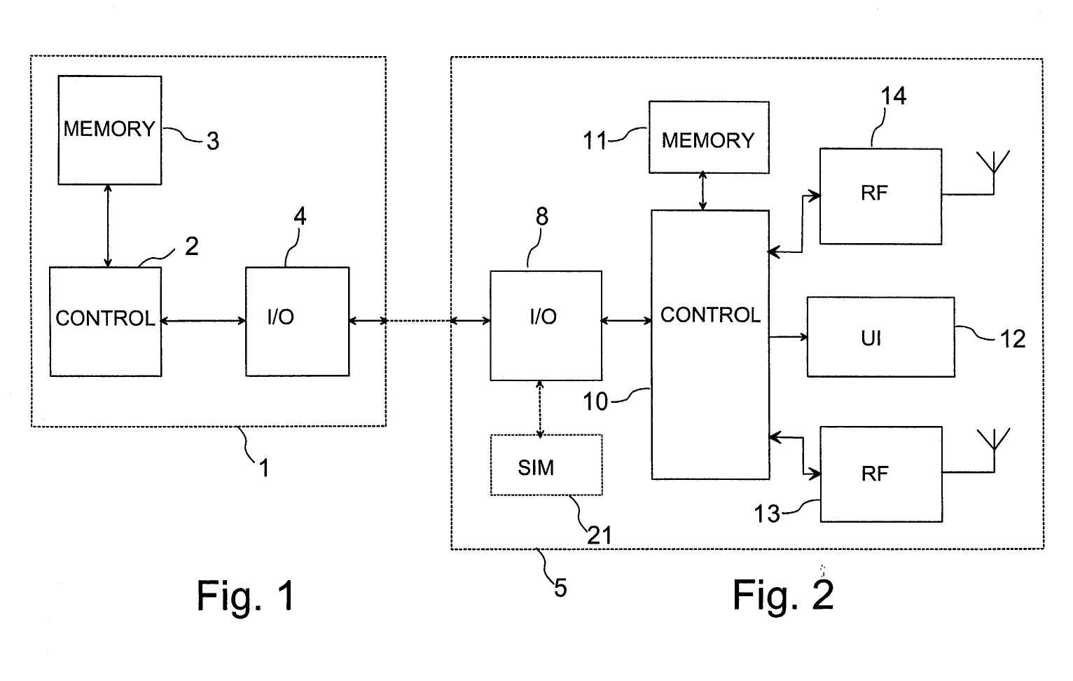

So-called cash cards are currently known, in which a user can load money in electrical form from an automatic teller machine (ATM) or the like. The user can use such a cash card for paying purchases at stores which have a card reader capable of reading the cash card. Such cash cards are typically based on smart card technology, wherein the card is provided with a microcircuit in which the cash card functions are implemented. FIG. 1 shows such a cash card implementation in a reduced block chart. The cash card 1 comprises a processor 2, a memory 3, as well as connection means 4. The processor 2 is used for processing the software necessary for the function of the cash card. The software is stored in a memory 3 which preferably comprises a read-only memory as well as a non-volatile random access memory. The read-only memory is used for storing programs, and the random access memory is used e.g. to indicate how much money is stored on the card. The connection means 4 make communication between the cash card and an external device possible e.g. upon loading money as well as upon paying.

To prevent abuse, various check-ups and encryptions are used in the implementation of the cash card to secure, upon loading of money, firstly that the person using the card is authorized to load money on the card and also that the sum of money to be transferred onto the card corresponds to the sum of money to be charged on the user's account. In a corresponding manner, when the cash card is used for payment, it can be checked that the person in possession of the card is authorized to pay with the card, that the sum of money on the card is sufficient for making the payment, and that the correct sum of money is transferred from the card to the recipient of the payment. Such a cash card is also called an electronic wallet. However, these check-ups are not performed upon payment with all cash card applications.

At present, cash cards can already be used for making a payment in several places. For example, in numerous stores, public swimming pools, taxes, hotels, etc., payments can be made by using a cash card. Furthermore, cash card applications are known which are only intended for specific uses, such as payment of a bus trip.

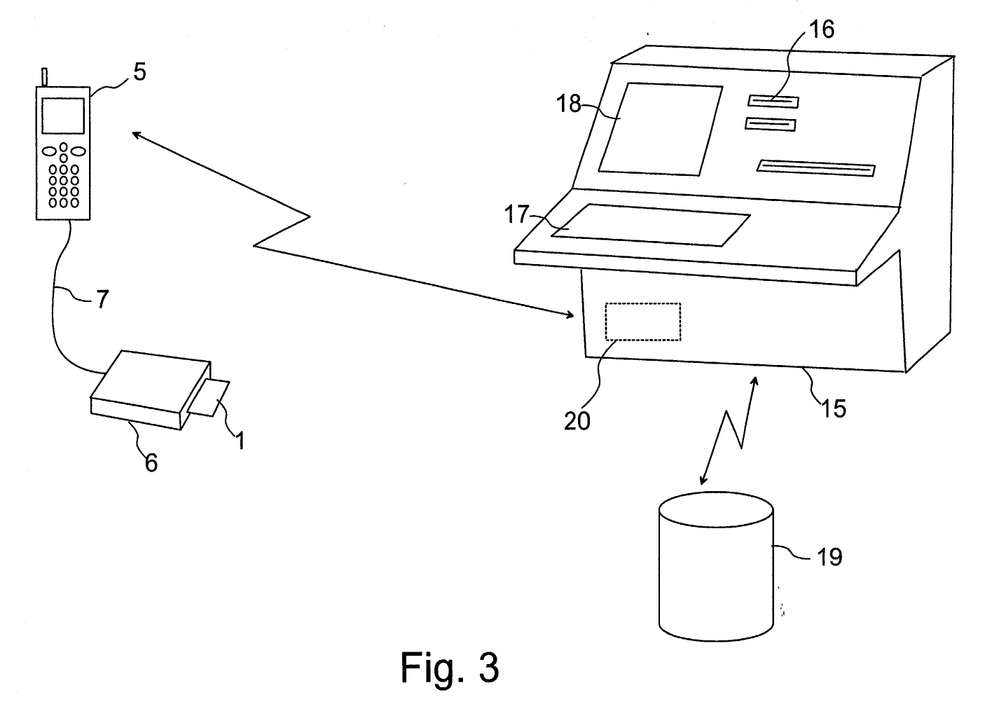

Money is loaded on the cash card at an automatic teller machine provided with a card reader for such a cash card. Thus, the user inserts the cash card in a card slot 16 (FIG. 3) intended for this purpose and provided with means for arranging communication between the card and the automatic teller machine. After this, the user uses a keyboard 17 to enter his/her personal identification number, after which the cash card and/or the automatic teller machine checks that the personal identification number has been correctly entered and that the card has not been deactivated for example for the reason that the card is reported to be stolen. If the card is in order and the personal identification number has been correctly entered, money can be loaded. The automatic teller machine requests the user to enter a sum that the user wishes to be loaded on the card. At this stage, the automatic teller machine can also display the sum of money available on the card at that moment, on a display 18. After the desired sum has been entered, the automatic teller machine transfers the money e.g. from a bank data system 19 onto the card. Thus, the sum of money transferred to the card is charged from a bank account, and the sum of money available on the card is increased respectively. Information on the money on the card is stored in the memory 3 of the cash card.

At the stage when the user wishes to pay with the cash card, the cash card is placed in a card reader and the user enters his/her personal identification number to confirm that the card belongs to the user. Information on the sum of money which should be charged from the card is transmitted from a cash register. After this, the card reader checks that the sum of money available on the card is sufficient for making the payment. If the sum of money is sufficient for making the payment, the sum of money corresponding to the payment is charged from the cash card and this sum of money is deposited on the account of the recipient of the payment. Thus, when the cash card is used, it is not actual physical money that is transmitted but information, wherein it is easier to use the cash card.

A drawback in using such a cash card is e.g. the fact that to load money, the user must find an automatic teller machine with means for loading the cash card. Furthermore, the user must insert the cash card in a card reader and enter his/her personal identification number and the sum of money to be transferred. In some situations, the user may forget to load money on the card, wherein upon making a payment, the sum of money on the card is not necessarily sufficient for making the payment. Thus, the user must find a suitable automatic teller machine, load money on the card and return to pay his/her purchases.

A wireless cash card has also been developed. In this case, the cash card is inserted in a connection device provided with wireless communication means. Thus, the cash card can communicate e.g. with a wireless phone equipped with corresponding wireless communication means. Thus, the user can load money on the cash card in such a way that the wireless phone sets up a data transmission connection e.g. to the home page of the issuer of the cash card in the Internet. This home page comprises an application whereby the user can load money in the same way as when loading money at an automatic teller machine. Consequently, the user enters his/her identification number and the sum of money to be loaded. The information on the sum of money to be transferred is transferred by means of a mobile communication network to the wireless phone and further via a local wireless communication connection to the cash card. Also this arrangement has, for example, the drawback that the user must enter his/her personal identification number and the sum of money to be transferred. Furthermore, if the communication connection is loaded, the loading of money can take a long time. In some situations, it may happen that the loading of money is not successful.

It is an aim of the present invention to eliminate the above-mentioned drawbacks to a major extent and to provide a method for loading money on a cash card, whereby the loading of money is performed automatically. The invention is based on the idea that the loading of money on the card is performed automatically in the vicinity of an automatic teller machine, if the sum of money on the card is smaller than a predetermined limit. The method according to the present invention is primarily characterized in what will be presented in the characterizing part of the appended claim 1. The electronic device according to the present invention is primarily characterized in what will be presented in the characterizing part of the appended claim 9. Further, the system according to the present invention is primarily characterized in what will be presented in the characterizing part of the appended claim 14.

Considerable advantages are achieved by the present invention when compared with cash card solutions of prior art. Applying the method of the invention, the loading of money on the card can be performed automatically, wherein the user does not need specifically to go to an automatic teller machine, to insert the card in a card reader, and to enter the personal identification number and the sum of money to be loaded. Thus, the user does not necessarily even notice that more money has been loaded on the card. Consequently, this arrangement saves the user's time. Automatic loading of money also has the advantage that the user does not need to remember to load money on the card.

In the following, the invention will be described in more detail with reference to the appended drawings, in which

FIG. 1 shows a cash card according prior art in a reduced block chart,

FIG. 2 shows, in a reduced block chart, an electronic device that can be used in connection with the method according to a preferred embodiment of the invention,

FIG. 3 shows an example of a system in which the method according to a preferred embodiment of the invention can be applied, and

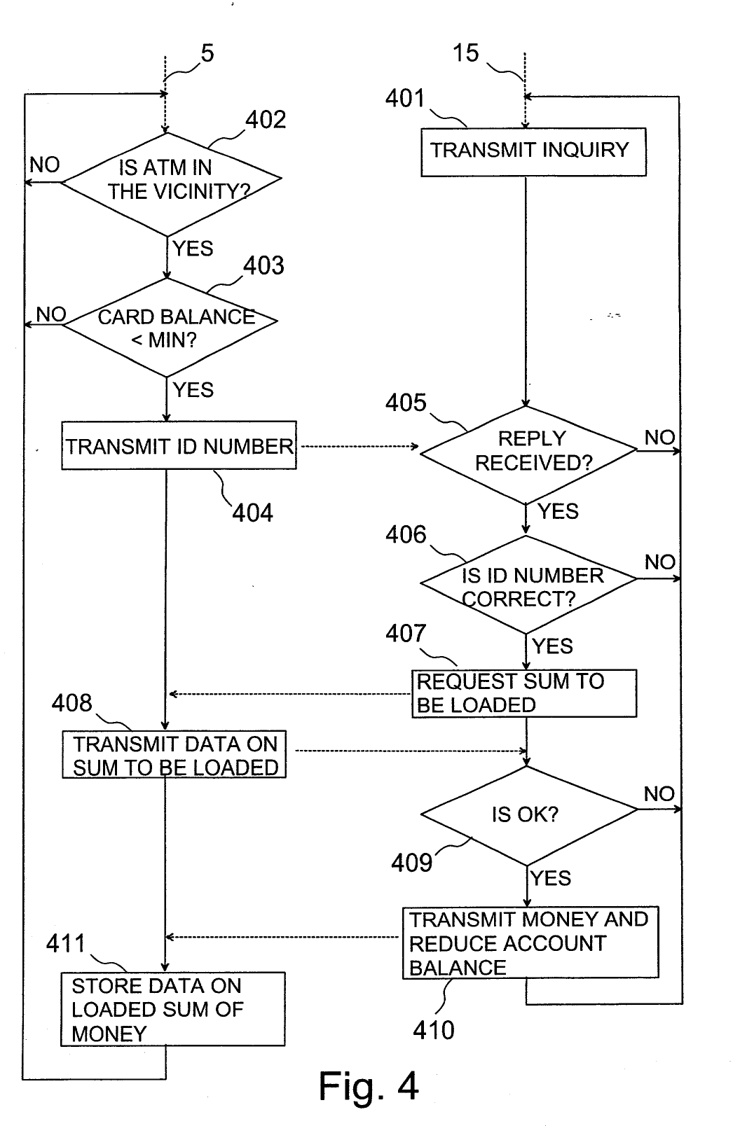

FIG. 4 shows, in a block chart, different steps in the method according to a preferred embodiment of the invention.

The following is a description on the operation of the method according to an advantageous embodiment of the invention, using a cash card 1 shown in FIG. 1 as an example of a cash card and an electronic device 5 shown in FIG. 2 as an example of an electronic device. The user places the cash card 1 in a card reader 6, as shown in FIG. 3. The card reader 6 is arranged in a data transmission connection with the electronic device 5. This data transmission connection can be a wired data transmission connection, wherein a cable 7 is coupled between the electronic device 5 and the card reader 6, or the data transmission connection can be a wireless data transmission connection, such as a short-range radio connection, of which one example to be mentioned in this context is the Bluetooth™ system. If the data transmission connection used between the electronic device 5 and the card reader 6 is a wireless data transmission connection, the card reader 6 must be provided with a separate power supply by means of batteries or the like. However, if a wired data transmission connection is used between the electronic device 5 and the card reader 6, the power supply for the card reader 6 and simultaneously for the cash card 1 can be arranged by means of a cable 7 from the electronic device 5. The electronic device 5 used in this preferred embodiment is a wireless communication device, but it is obvious that also other electronic devices can be used in connection with the invention. The electronic device 5 is provided with first connection means 8 for providing communication between the electronic device 5 and the card reader 6. The electronic device 6 is provided with first connection means 9 for providing communication between the electronic device 5 and the card reader 1. These communication means 9 of the card reader are coupled with the communication means 4 of the cash card 1. These communication means 9 of the card reader 6 comprise for example mechanical coupling means for coupling the conductors of the cable 7 to corresponding pins (not shown) in the connection means 4 of the remote card 1. Thus, the connection wire 7 preferably has a conductor for each pin in the connection means 4 of the remote card. It is obvious that the card reader 6 can also comprise connection means 9 of another type, in which it is possible to make e.g. protocol conversions and other data processing operations. Thus, data can be transmitted from the card reader 6 to the electronic device 5 in a different format than when transferred directly from the cash card 4 to the electronic device 5. If a wireless data transmission connection is used between the electronic device 5 and the card reader 6, the connection means 9 of the card reader 6 comprise means for implementing this wireless data transmission connection.

The electronic device 5 preferably comprises a processor 10, memory means 11, a user interface 12, a radio part 13, and local communication means 14.

When the cash card 1 is placed in the card reader 6, the cash card 1 is preferably identified in the following way. The electronic device 5 identifies the type of the cash card 1 and requests the user to give his/her own personal identification number corresponding to this cash card. The identification number is transmitted from the electronic device 5 to the cash card 1, in which the connection means 4 transfer the information to the processor 2. The processor 2 checks that the identification number corresponds to the identification number stored on the card 1, after which the cash card 1 transmits acceptance information to the electronic device 5. If the identification number does not match, the cash card 1 reports to the electronic device 5 that the identification number is incorrect. If the identification number has been correctly entered, the user can for example check the balance on the cash card 1 by selecting the respective function by means of the user interface 12 of the electronic device 5. By means of the user interface 12, the user can also switch on the function of automatic loading by the electronic device 5. In this connection, the user can also set a condition for performing the automatic loading. This loading condition can be e.g. a minimum limit, a maximum limit, an average balance on the card, a day and time of the week, a location, etc. The minimum limit indicates how much money the user wishes to have on the cash card 1 In addition to the minimum limit, the user can advantageously set the sum of money to be loaded at a time, or the setting can be made to load so much money on the cash card 1 that the minimum limit will be exceeded. By setting a maximum limit, the user can restrict the balance of the card to a desired upper limit, wherein upon loading the card, it is checked that the maximum balance will not be exceeded. An average card balance can be determined e.g. for a time of a month, wherein upon loading the card, a sum of money is loaded whereby the balance of the card is made substantially to the averange balance. Furthermore, the above-mentioned loading condition based on time can be applied for example in such a way that for a weekend, a larger sum of money is loaded on the card than for weekdays. The loading condition can also be limited to time, wherein, for example, a smaller minimum and/or maximum limit is used in the evening than in daytime. The location data can be determined e.g. for an automatic teller machine, wherein loading is performed e.g. when the user is in the vicinity of an automatic teller machine located at a shopping centre, a service station or the like. It is obvious that in connection with the present invention, also other loading conditions can be determined than those presented above, and that different loading conditions can also be used in combination, e.g. minimum and maximum limits.

Furthermore, the personal identification number entered by the user can be stored e.g. in the memory means 11 of the electronic device 5, wherein the user does not need to enter the identification number upon automatic loading according to a preferred embodiment of the invention. The user can also set the identification number of the cash card to be the same as the identification number possibly related to the user of the electronic device 5, such as the PIN code (Personal Identity Number) known from wireless communication devices.

Turning on the automatic loading function will set the local communication means 14 of the electronic device 5 to receive a signal transmitted by an automatic teller machine 15 preferably at intervals (FIG. 3). Thus, in a situation in which the user is in the vicinity of an automatic teller machine 15 provided with wireless local communication means 20 for automatic loading, the local communication means 14 of the electronic device 5 receive an inquiry message transmitted by the automatic teller machine 15. In the flow chart of FIG. 4, the transmission and the examination of this inquiry message are represented by blocks 401 and 402, respectively. After the electronic device 5 has received the inquiry message, the electronic device 5 checks the sum of money on the cash card 1 (block 403). If the sum of money on the cash card 1 is smaller than the set minimum balance, money will be loaded on the cash card 1.

In a preferred embodiment of the invention, money is loaded in the following way. The electronic device 5 transmits the identification number of the cash card 1 by the local communication means 14 (block 404). The automatic teller machine 15 listens if any device has replied to the inquiry message (block 405). After the automatic teller machine 15 has received the identification number transmitted from the electronic device 5, the automatic teller machine 15 checks that the identification number corresponds to an identification number stored in the bank data system 19 (block 406). After checking the identification number and verifying that it is correct, the automatic teller machine 15 sends an acknowledgement message and inquires the sum of money to be loaded (block 407). After receiving the acknowledgement and inquiry message, the electronic device 5 investigates how much money should be loaded on the cash card 1. The sum of money to be loaded is either fixed or such that the minimum limit will be exceeded, as already mentioned above in this description. The electronic device 5 transmits information about the sum of money to be loaded by the local communication means 4 (block 408). After this, the automatic teller machine 15 checks the balance on the account (block 409), and if the account balance is sufficient for performing the loading, the automatic teller machine 15 sends a message informing about loading of the money (block 410). If the sum of money on the account is not sufficient for performing the loading, the automatic teller machine sends e.g. information on how much money is available on the account for loading, or sets the sum of loading to be for example zero, wherein the electronic device 5 can deduce on the basis of this that no money can be loaded on the card 1. On the other hand, bank accounts with credit facility are known, wherein the amount exceeding the balance on the account is booked as credit for the user and loading can be performed normally.

The electronic device 5 receives the message transmitted by the local communication means 20 of the automatic teller machine 15, examines from the message e.g. the sum of money to be transmitted, and then stores it on the cash card 1 (block 411). The loading of money is preferably performed in the following way. The electronic device 5 transmits a message via the first connection means 8 to the cash card 1, and in this message, information is transmitted about the sum of money to be deposited on the card 1. The processor 2 of the cash card 1 checks the validity of the data transmission, after which the processor 2 changes the information in the memory 3 about the sum of money stored on the card 1 to correspond to the new situation.

It is obvious that in the above-mentioned operations of money transfers, various confirmations and checkings are performed, and further, the information is transmitted in encrypted format to prevent abuse. However, this is prior art known by anyone skilled in the field, wherein its description in more detail will not be necessary in this context.

In the above description of the method according to a preferred embodiment of the invention, a system was used where the electronic device 5, the card reader 6 and the cash card 1 are separate devices; however, it is obvious that also other types of systems can be applied in connection with the invention. For example, the functions of the card reader 6 can be implemented in connection with the electronic device 5, wherein the cash card 1 is placed in corresponding means in the electronic device 1 to connect the cash card 1. In another embodiment, the cash card 1 can be implemented in connection with another card, such as an identification card 21 (shown with broken lines in FIG. 2) for a user of a wireless communication device, preferably in connection with a SIM card (Subscriber Identity Module). In this case, a separate cash card 1 is not necessarily required. In this embodiment, payment is made in a wireless manner for example by means of the local communication means 14 of the electronic device 5. Thus, the receiver of the payment should have a corresponding device which is capable of communicating with the electronic device 5. On the other hand, the payment can also be made by means of the radio part 13, wherein separate local communication means 14 are not necessarily needed in connection with the payment.

The following is a description on the operation of the method according to an advantageous embodiment of the invention, using as an example of an electronic device an electronic device 5 in which the functions of the cash card 1 are provided in connection with a user identification card 21. In this context, the GSM mobile phone should be mentioned as a non-limiting example of such a wireless communication device. In this embodiment, the electronic device 5 does not necessarily require a card reader 6 or a cable 7. Furthermore, as the cash card controller 2, memory 3 and communication means 4, the corresponding functional blocks of the identification card are advantageously used, but for clarity, they are not shown in connection with the identification card of FIG. 2.

The user has turned on the wireless communication device, wherein it has logged in a mobile communication network (not shown) in a way known as such, if it has been possible in view of the resources and connection quality in the mobile communication network at the time. In the method, to determine the need for loading money, the realization of the loading condition determined for the cash card is preferably examined at intervals and/or in connection with a payment operation, e.g. by comparing the deposited sum of money with the set minimum sum. If the loading condition is fulfilled, it is examined if the wireless communication device can set up a connection to the mobile communication network at the moment. If a connection can be set up, a loading request is transmitted from the wireless communication device 5 to the mobile communication network, from which it is further transmitted to the data system of the financial institution e.g. by calling a determined telephone number. After this, the wireless communication device 5 and the data system of the financial institution communicate with each other e.g. to find out the user's account data. Furthermore, the electronic device 5 transmits information about the sum of money to be loaded.

After this, the money is transferred from the data system of the financial institution to the wireless communication device 5 via the mobile communication network by using communication methods known as such. In the wireless communication device 5, the sum of money deposited on the cash card is changed accordingly. In this embodiment, the means 15 for loading money thus comprise a mobile communication network.

If the cash card 1 used is a separate cash card known as such, the payment can be made in a way known as such by removing the cash card 1 from the card reader 6 and placing it in the corresponding card reader of the recipient of the payment. Thus, the user enters his/her personal identification number, after which a sum of money corresponding to the payment is deduced from the cash card 1 presuming that the sum of money on the cash card 1 is sufficient for making the payment.

The invention has been described above in connection with the cash card 1; however, the method according to the invention can also be applied in connection with charge cards intended for the payment of e.g. bus fees. Thus, means for performing loading are provided e.g. in the vicinity of bus stops. These loading means preferably transmit inquiry messages, wherein an electronic device 5 located in its close vicinity and complying with an advantageous embodiment of the invention, detects the inquiry message, checks the sum of money on the charge card, and if the sum of money is smaller than the set minimum limit, money is loaded on the charge card. On such a charge card, it is possible to load e.g. a certain sum of money or a sum of money corresponding to a certain number (e.g. 1) of bus trips.

It is obvious that the present invention is not limited solely to the above-presented embodiments, but it can be modified within the scope of the appended claims.

1. A method for loading money from money loading means (15) to money depositing means (1), wherein money is deposited in electrical format, characterized in that in the method, a loading condition is determined, a signal transmitted by the money loading means (15) is received, and said loading condition is examined, wherein loading takes place automatically, if the loading condition is fulfilled and if the signal transmitted by the money loading means (15) can be received.

2. The method according to claim 1, characterized in that said loading condition used is a minimum sum, wherein in the method, the sum of money deposited in the money depositing means (1) is compared with said minimum sum, and loading takes place, if the deposited sum of money is smaller than said minimum sum.

3. The method according to claim 1 or 2, characterized in that said loading condition used is a maximum sum, wherein in the method, the sum of money deposited in the money depositing means (1) is compared with said minimum sum, and loading takes place, if the deposited sum of money is smaller than said maximum sum.

4. The method according to claim 1, 2 or 3, characterized in that in the method, also the sum of money to be loaded at each loading time is determined.

5. The method according to any of the claims 1 to 4, characterized in that in connection with the loading of money, an identification number is transmitted to the money loading means (15) for identification of the user.

6. The method according to any of the claims 1 to 5, characterized in that a cash card is used as the money depositing means (1).

7. The method according to any of the claims 1 to 6, characterized in that an automatic teller machine is used as the money loading means (15).

8. The method according to any of the claims 1 to 6, characterized in that a mobile communication network is used as the money loading means (15).

9. An electronic device (5) provided with money depositing means (1) comprising means (8) for setting up a data transmission connection to money loading means (1), and means (8, 10, 13) for loading money from the money loading means (15) to the money depositing means (1), characterized in that it comprises means (12) for determining a loading condition, means (13) for receiving a signal transmitted by the money loading means (15), and means (10) for examining the loading condition, wherein the loading is arranged to be performed automatically, if the signal transmitted by the money loading means (15) can be received and if said loading condition is fulfilled.

10. The electronic device (5) according to claim 9, characterized in that the means (13) for loading money comprise wireless communication means.

11. The electronic device according claims 9 or 10, characterized in that the money depositing means (1) comprise a cash card.

12. The electronic device (5) according to any of the claims 9 to 11, characterized in that it comprises an identification card for identifying the user of the electronic device, and that the money depositing means (1) are arranged in connection with said identification card.

13. The electronic device (5) according to any of the claims 9 to 12, characterized in that it comprises means for performing functions of a mobile station.

14. A system for loading money, comprising money loading means (15), money depositing means (1), an electronic device (5) provided with the money depositing means (1), means (8) for setting up a data transmission connection between the electronic device (5) and the money loading means (1), and means (8, 10, 13) for loading money from the money loading means (15) to the money depositing means (1), characterized in that the system comprises means (12) for determining a loading condition, means (20) for transmitting a signal from the money loading means (15), means (13) for receiving the signal transmitted by the money loading means (15), and means (10) for examining the loading condition, wherein the loading is arranged to be performed automatically, if the signal transmitted by the money loading means (15) can be received and if said loading condition is fulfilled.
